(19) United States
(12) Patent Application Publication
(10) Pub. No.: US 2012/0115114 A1
(43) Pub. Date: May 10, 2012

(54) Apparatus and Methods for Coaching Salespersons

(76) Inventors: Donal Daly, Cork (IE); Tammy Billington Dynes, Wicklow (IE)

(21) Appl. No.: 12/943,439

(22) Filed: Nov. 10, 2010

(51) Int. Cl. G09B 19/00

(52) U.S. Cl. 434/219

(57) ABSTRACT

Methods, systems, and apparatus to coach a salesperson to complete a sale. One aspect is a computer-implemented method of coaching a salesperson to complete a sale including the steps of entering into a database information about an entity to whom the salesperson wishes to sell; entering into the database information about a sales opportunity of the entity; instantiating objects in the database in response to the entered information; executing a rule set over the instantiated objects; and displaying the results of executing the rule set. In one embodiment the step of displaying includes displaying a set of suggestions relating to completing the sale. Another aspect of the invention relates to a computer system for coaching a salesperson to complete a sale including a processor and a database. The processor executes a set of rules on a set of objects to generate a set of suggestions relating completing a sale.

### FIELD OF THE INVENTION

The present invention relates to the field of computer aided coaching and, in particular, to systems to help salespersons achieve their goals.

### BACKGROUND

Each domain has a set of rules or behaviors by which individuals operating within the domain act to accomplish the goals of the domain. Individuals who are successful in a domain typically act on these rules or behaviors almost instinctively and may develop their own rules as they acquire experience.

Transferring these rules or behaviors to others operating in the domain requires significant effort. Frequently consultants are used to teach such rules and behaviors to a less experienced group working within the domain. The absorption of this knowledge takes time and those inexperienced individuals may be prone to making mistakes that require significant supervision or coaching to avoid.

Sales, within a specific industry, is an example of such a domain. Good salespersons can be used to train less experienced salespersons. However, this takes those good salespersons from their primary job, sales. What is needed is some way to coach salespeople without distracting experienced salespersons from their primary jobs.

The present invention addresses this need.

### SUMMARY OF THE INVENTION

In general, the invention provides various methods, systems, and apparatus to coach a salesperson to complete a sale. One aspect of the invention is a computer-implemented method of coaching a salesperson to complete a sale. The method includes the steps of entering into a database information about an entity to whom the salesperson wishes to sell; entering into the database information about a sales opportunity of the entity; instantiating objects in the database in response to the entered information; executing a rule set over the instantiated objects; and displaying the results of executing the rule set. In one embodiment, the step of displaying includes displaying a set of suggestions relating to completing the sale. In another embodiment, the suggestions comprise one or more of: determining to whom the salesperson should make contact, determining any missing steps in an action plan, and determining competitive advantages. In yet another embodiment, all the rules operate on all the objects. In still yet another embodiment each of the rules belongs to a group of rules comprising: a political map; a strategy; a collaboration map; a prime action; decision criteria; a competitor; an opportunity, and an assessment.

Another aspect of the invention relates to a computer system for coaching a salesperson to complete a sale. In one embodiment, the system includes a processor and a database in communication with the processor. The database includes a set of objects and a set of rules for operating on the set of objects. In one embodiment, the processor executes the set of rules on the objects to generate a set of suggestions relating completing a sale to the salesperson in response to the objects and rules. In another embodiment, the system includes an input device for entering into the database information about an entity to which the salesperson wishes to sell; and a display for displaying the set of suggestions relating to completing the sale. In one embodiment, the rules operate on all the objects of the database.

Yet another aspect of the invention is a computer-implemented method of coaching a user in how to act within a sales domain. In one embodiment, the method comprises the steps of: entering into a database information about the sales domain, instantiating objects in the database in response to the entered information; executing a rule set over the instantiated objects; and displaying the results of executing the rule set, wherein the displaying includes a set of suggestions relating to desired actions within the sales domain. In yet another embodiment, all the rules operate on all the objects in the database.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a schematic diagram of an embodiment of the system of the invention;

FIG. 2 is an embodiment of a data entry and display page for entity information;

FIG. 3 is an embodiment of a data entry and display page for opportunity information;

FIG. 4 is an embodiment of a data entry and display page for entity organization;

FIG. 5 is an embodiment of a data entry and display page for a collaboration map;

FIG. 6 is an embodiment of a data entry and display page for decision criteria;

FIG. 7 is an embodiment of a data entry and display page for action items;

FIG. 8 is an embodiment of a data entry and display page for assessment;

FIG. 9 is an embodiment of a rule editing page; and

FIG. 10 is an embodiment of rule generated instructions for coaching the salesperson regarding the sale opportunity.

### DETAILED DESCRIPTION

Prior to discussing various embodiments of the invention, it is helpful to provide an outline of certain features of this application. For example, the use of headings and sections in the application is not meant to limit the invention; each section can apply to any aspect, embodiment, or feature of the invention.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

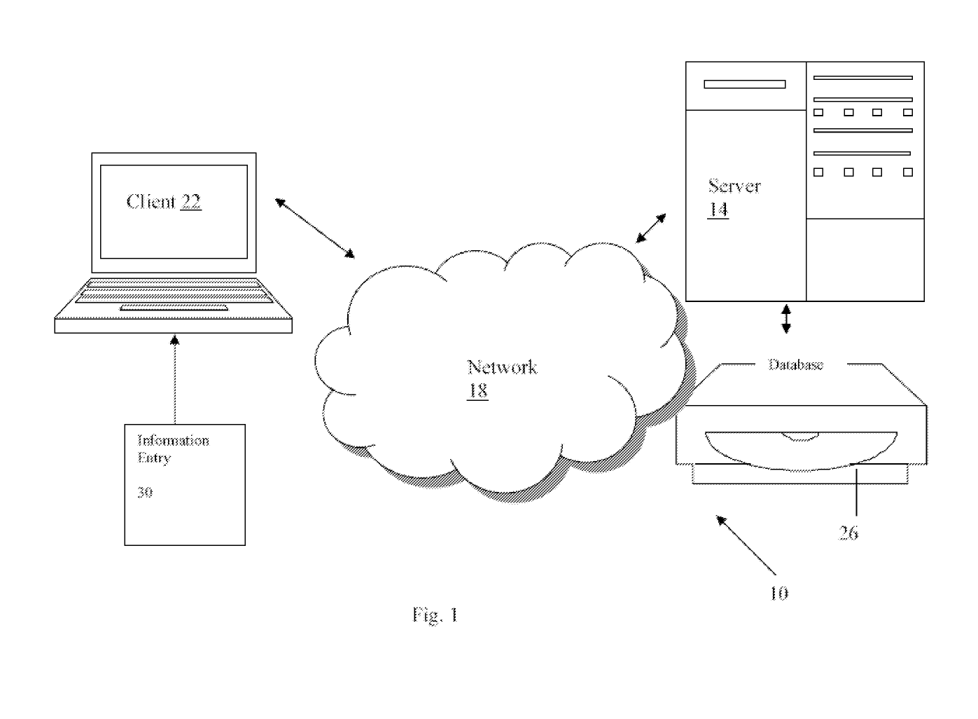

In brief overview and referring to FIG. 1, a system 10 constructed in accordance with the present invention in one embodiment includes a server 14 which is in communication with a client 22 through a network 18. Information entry 30 through the client 22 and received by the server 14 is stored in a database 26. The server 14 constructs a number of objects from the information 30 and stores those objects in database 26. Database 26 also contains a series of rules specific to the domain of interest. For example the domain may be selling software to an entity. Further the database may include a series of rules common to all domains.

The system of the present invention differs from typical expert systems. In a typical expert system the rules modify the database, cause other rules to execute; collide with other rules and potentially are arbitrated out of executing in favor of other rules. In the present invention all rules are applied to the database, no rules collide, no database entries are modified and all the rules that are triggered by entries in the database execute. Thus if two rules meet the values of the parameters as they exist in the database, then both execute and cause the individual recommendations associated with each rule to be displayed.

The present invention may be embodied in many different forms, including, but in no way limited to, computer program logic for use with a processor (e.g., a microprocessor, microcontroller, digital signal processor, or general purpose computer), programmable logic for use with a programmable logic device, (e.g., a Field Programmable Gate Array (FPGA) or other PLD), discrete components, integrated circuitry (e.g., an Application Specific Integrated Circuit (ASIC)), or any other means including any combination thereof In a typical embodiment of the present invention, some or all of the processing of the data collected and the processor-based system is implemented as a set of computer program instructions that is converted into a computer executable form, stored as such in a computer readable medium, and executed by a microprocessor under the control of an operating system. Thus, query response and input data are transformed into processor understandable instructions suitable for generating features and embodiments described above.

In the embodiments described herein the rules are written in SQL code. However, computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system.

Memory may also include any means for storing software or other instructions including, for example and without limitation, a hard disk, an optical disk, floppy disk, DVD (digital versatile disc), CD (compact disc), memory stick, flash memory, ROM (read only memory), RAM (random access memory), DRAM (dynamic random access memory), PROM (programmable ROM), EEPROM (extended erasable PROM), and/or other like computer-readable media.

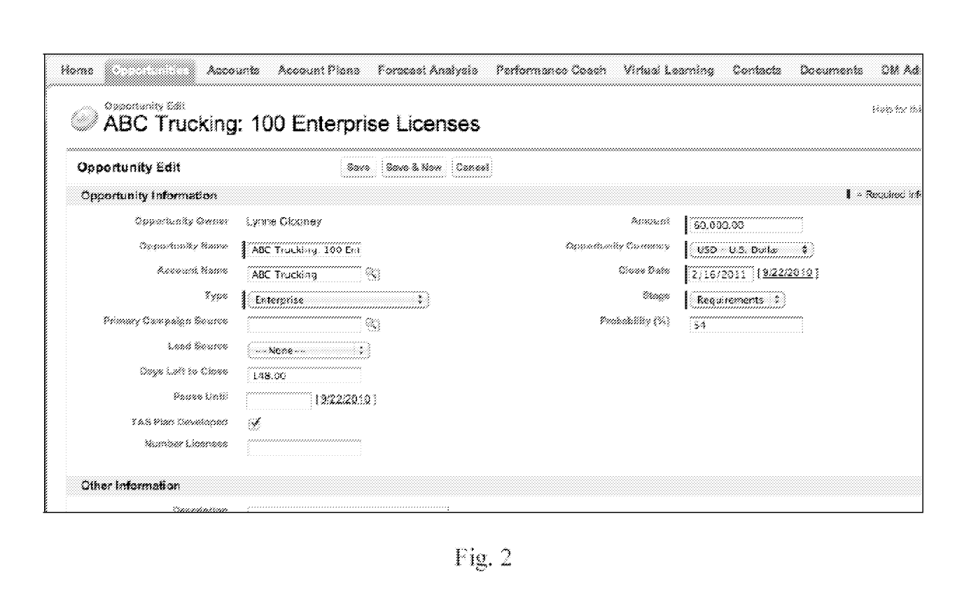

FIG. 2 is an example of a populated data entry and display screen (the Opportunity Screen) according to one embodiment of the invention. In this screen the salesperson name is entered (Lynne Clooney), as is the name of the entity (ABC Trucking), the estimated time left until the deal is closed (148 days); the potential value of the deal ($60,000) and the stage of the opportunity (Requirements Stage).

Although the stages of an opportunity, or more correctly a pipeline, differ from one implementation to the next, potential stages frequently used include: (1) target company selected, (2) target opportunity qualified or is worth pursuing, (3) opportunity requirements defined, (4) evidence presented to the customer that a product offered by the sales person can meet the requirements of the target opportunity, (5) acquisition or helping the target company through the steps necessary to purchase the product, and (6) verbal order from the target company which is to be followed by a written purchase order or statement of work.

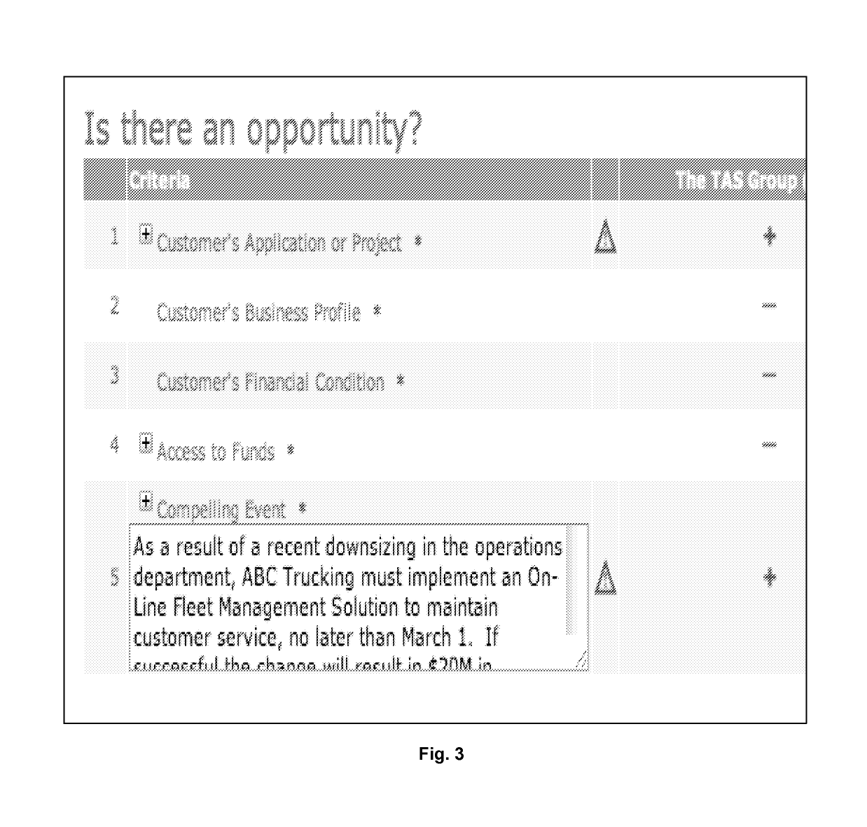

Other fields may be included in this and other embodiments as is deemed appropriate by the company for whom the salesperson works. The system 10 then generates a new screen, (the Opportunity Validation screen) (FIG. 3) asking for information about the specific opportunity including what makes this opportunity available at this time.

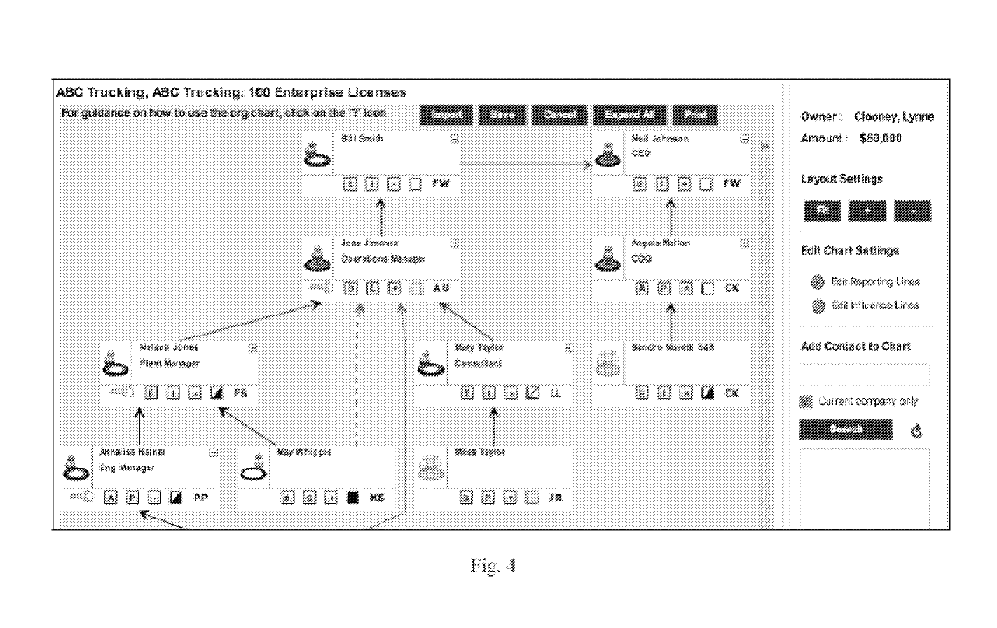

The next screen, FIG. 4, is the input and data display screen (the Organization screen) for the organization of the entity to which the sale opportunity is available. This screen accepts input from the user to create the model of the organization and also displays modifications and augmentations to the display caused by the execution of the rules. It is important to realize that this is not simply an organization chart as would be supplied by the entity itself. It is an organization chart made from intelligence gathered by the salesperson or other user about the company. So for example, if there were a secretary to the Chief Executive Officer (CEO) who had been with the company for twenty years and as such had a great deal of information about the company and whose opinion was trusted by the CEO, she might be included on this organization display even though she might not appear in the entity's official organization chart.

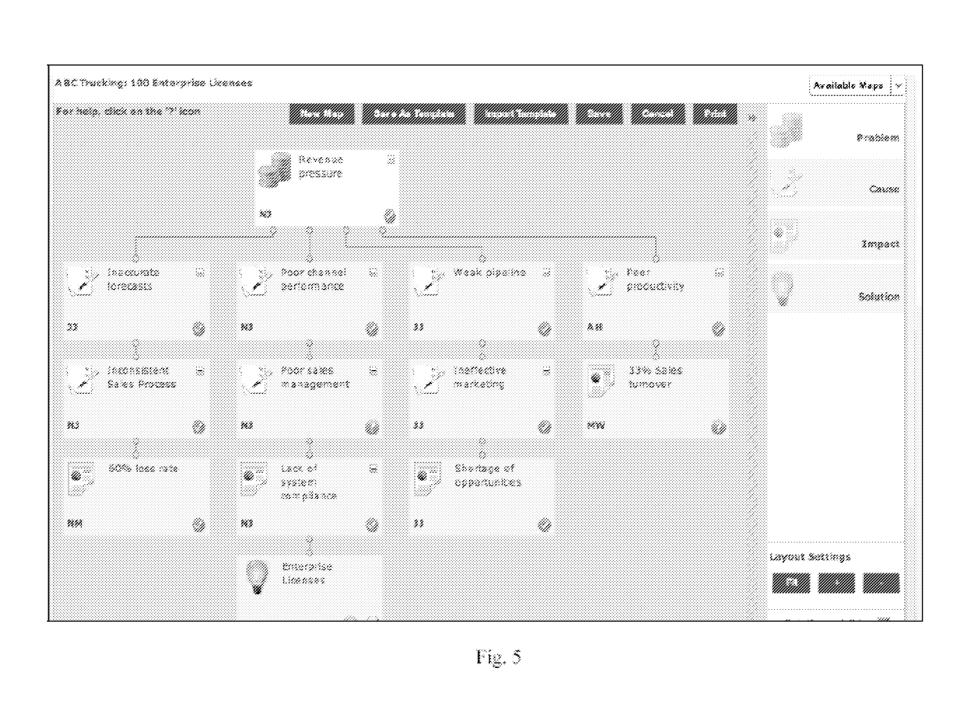

The organization chart as displayed includes not only the names, titles and reporting arrows of a standard chart, but also a designation of whether the person is a decision maker, what the level of political influence is of that person, who in the salesperson's company knows the person in the entity, what the level of contact is with this person within the entity, and finally what the person's feelings are toward the salesperson's company (friendly, antagonistic, etc). Although the reporting structure entered by the user or salesperson may be shown, the rules engine may augment this by depicting direct connection to those in power to help make the sale. So in the diagram shown, May Whipple is the salesperson's contact within the entity and she reports to Nelson Jones the plant manager. Nelson Jones in turn reports to Jose Jimenez the operations manager. Jose Jimenez is determined to be a decision maker by the system and through other information the system determines that May Whipple is capable of making an introduction directly with Jose without the salesperson having to go through Jones, who is not a decision maker. The system depicts this “back channel” connection with a dotted arrow. Next, the system asks the salesperson to enter data into display termed the Collaboration Map, FIG. 5. This map is to show the relationship of various Problems, Causes, Impacts and Solutions for the issues faced by the entity. So in the example shown, the entity is facing a Problem of “revenue pressure”. There are many causes of this “revenue pressure”. Some of the causes result in other Causes that in turn result in “revenue pressure”. For example the Cause “inconsistent sales process” results in the Cause “inaccurate forecasts” which contribute to the Problem “revenue pressure”. The impact of these Causes is “60% loss rate” in sales. This Impact may be quantitative as in this example or qualitative as in the Impact “shortage of opportunities”. The information to accomplish the construction of this map comes from the salesperson working with various members of the entity.

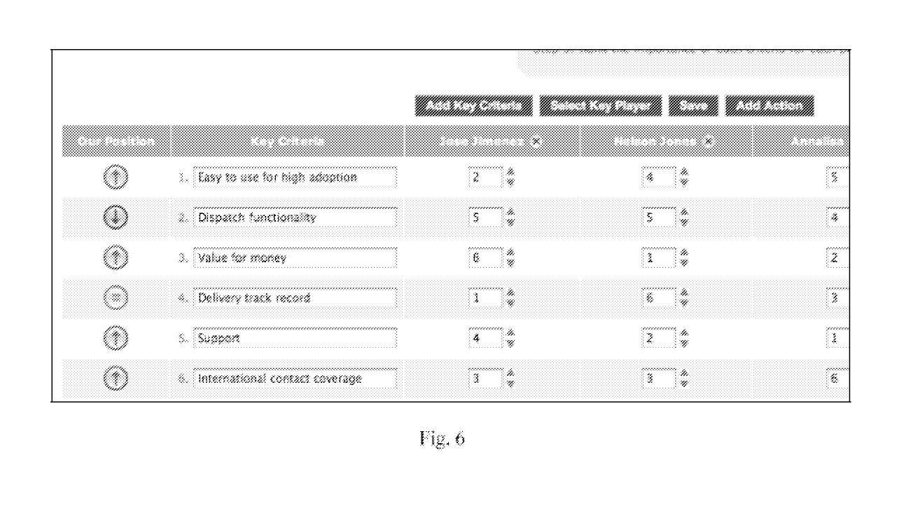

The next screen is the Decision Criteria screen (FIG. 6). This screen displays key criteria such as what the salesperson's company thinks of its own abilities relative to the criteria, a list of the decision makers or other key players and the rank importance of those criteria to the key payers. So for example, the salesperson company believes that it has an easy to use product and Jose Jimenez thinks “ease of use” is the second most criteria for buying a product. On the other hand, Nelson Jones ranks “ease of use” as number 4 in rank. As a result, the salesperson can easily map which criteria the company meets and with whom to stress those criteria.

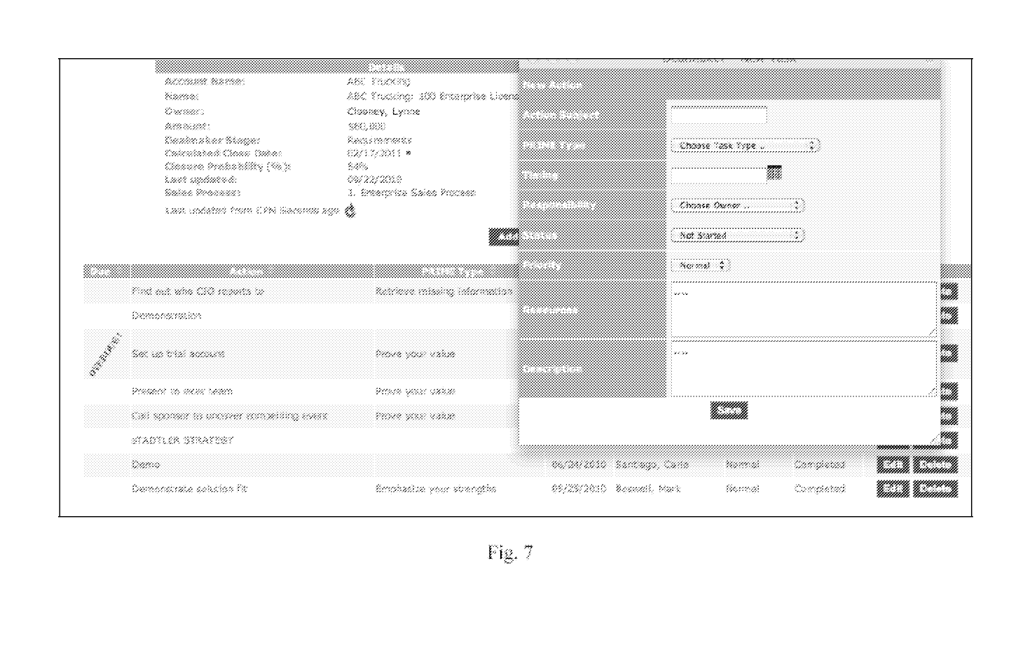

FIG. 7 is an embodiment of the data entry screen is the Action Item screen. This screen allows the salesperson to construct a list of action items and the system will keep track of when they have been accomplished and highlight important actions that have not yet been addressed.

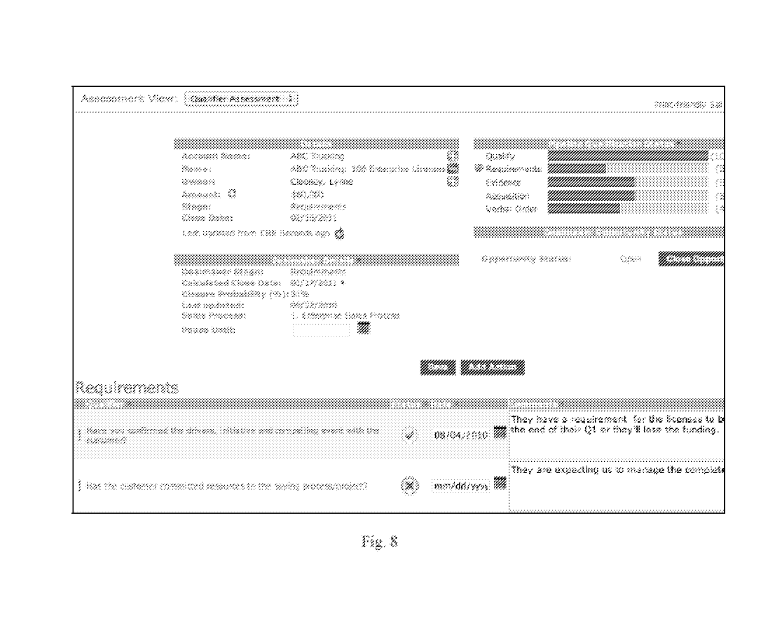

FIG. 8 is an embodiment of an Assessment screen. The system uses this screen to solicit from the salesperson basic answers to whether or various steps have been taken by the salesperson in the process.

Once the fields in the various screens have been entered, the system uses the input data to instantiate a series of objects. These objects include value of the deal; who reports to the CEO; problems to be solved for the entity; and so on.

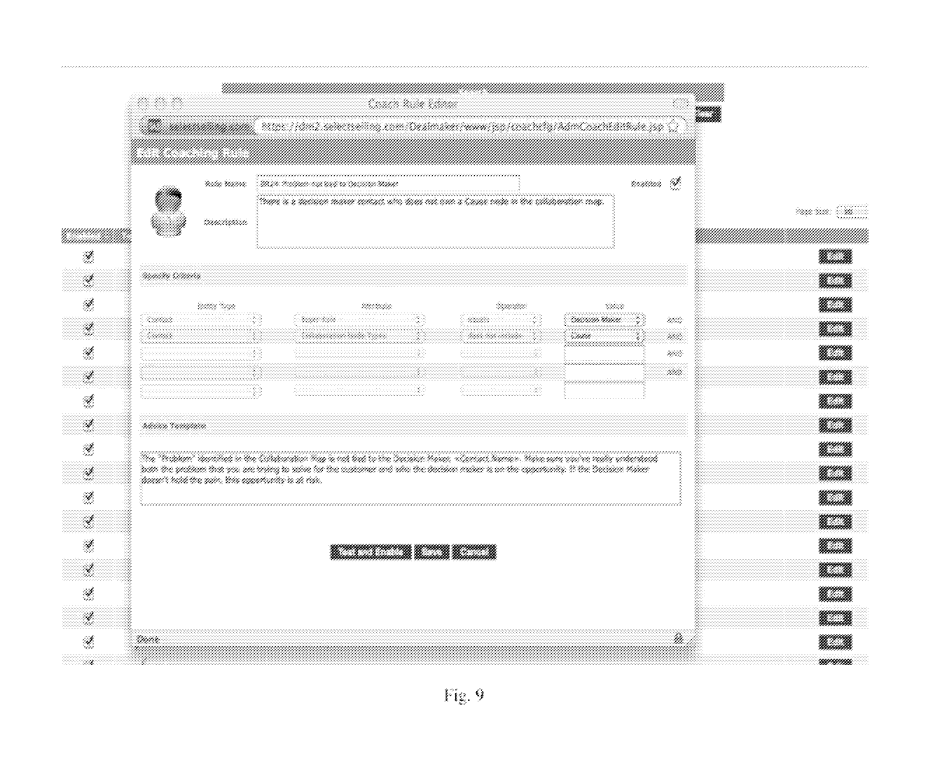

The objects are then operated upon by rules that are specific to the domain of interest, for example selling to the transportation industry. Some rules are pre-generated as being common to all sales domains. Other rules are specific to a given domain and are added by way of the Rule Editor screen or user interface (FIG. 9).

The rules may be of several types. For example, one type of rule checks one or more parameter values and in response to those parameter values executes if those parameter values are met. Unlike standard expert systems, all rules execute on the objects at a given time. That is to say, there are no collisions possible between rules. For example, one rule could be:

IF (Opportunity Amount>$1M) AND IF (Stage=Acquisition) AND IF (Decision Maker Contact=‘null’) THEN WRITE (“Contacts have not been made with the proper contacts within the entity. Review organization chart to determine who the decision makers are and who to contact to approach them.”)

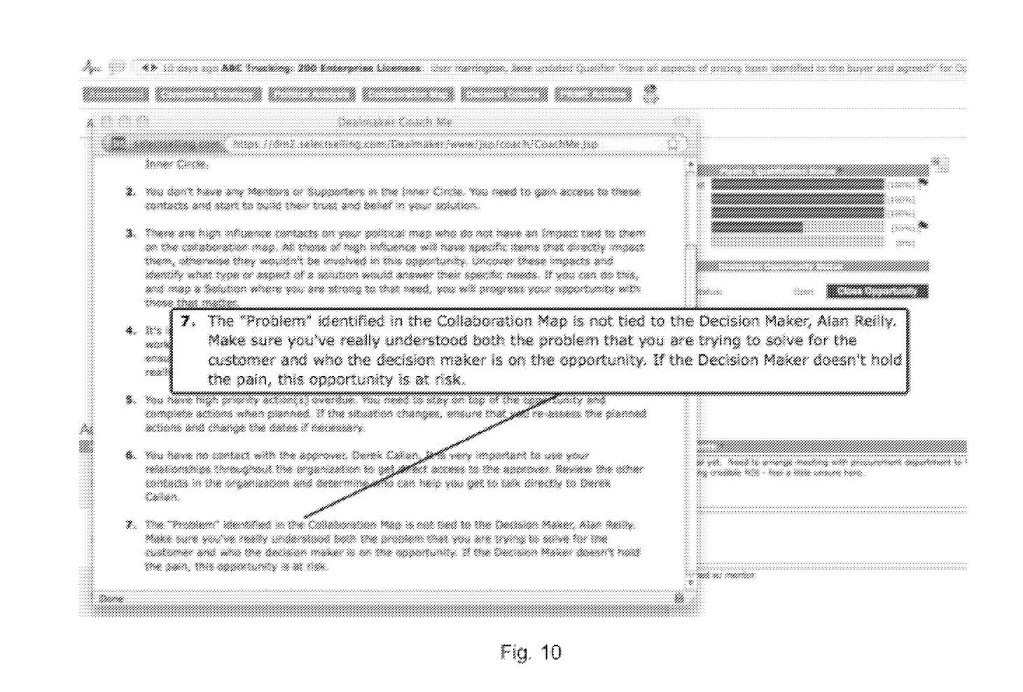

This rule which looks at the Opportunity Amount and the Stage of the process from the Opportunity screen and the list of Decision Makers and whether or not they have been contacted from the Organization screen, and if the rule's conditions are met, the system displays the recommendation “Contacts have not been made with the proper contacts within the entity. Review organization chart to determine who the decision makers are and who to contact to approach them.” on the Coaching screen (FIG. 10).

A second type of rule searches for missing data and reminds the salesperson that the data is needed. For example:

IF (Close Date=‘null’) THEN WRITE (“A prospective Close Date is required to provide accurate advance warnings. Check with entity to determine when a decision on purchasing will be made.”)

Thus, if the Close Date field in the Opportunity screen is blank, this rule would also execute and the output “A prospective Close Date is required to provide accurate advance warnings. Check with entity to determine when a decision on purchasing will be made.” would also appear on the Coaching screen.

In one embodiment the rules fall generally into one of ten general categories:

Political map—This category generally deals with rules related to the politics of the situation. (Example: What to do if the decision maker in the opportunity is adverse)

General—This category generally deals with rules that are common over all domains. (Example: What to do if it is not determined whether the prospective solution fits the problem at a late stage in the sales process.)

Strategy—This category deals with general strategy issues. (Example: What to do if the opportunity is in a late stage with no strategy determined.)

Collaboration map—This category deals with the problems of the entity and how they will be addressed. (Example: What to do if no competitive advantage is identified at the current stage of the opportunity.)

Prime Action—This category relates to actions that are needed in the opportunity. (Example: What needs to be done to determine that the opportunity is real.)

Qualifier—The category relates to steps necessary to qualify the opportunity. (Example: A warning that insufficient information has been entered to qualify the opportunity.)

Decision criteria—The category relates to criteria required to be met for a decision to occur. (Example: What to do if key players in the entity have not been identified at an early stage of evaluating the opportunity.)

Competitor—This category relates to the competition which are after the same sales opportunity. (Example: What to do if there is a sizable opportunity but no competitors have been identified.)

Opportunity—This category relates to the core details of the opportunity as manually entered by the sales person (Example: What to do if the sales person's assessment of the opportunity indicates it's further along in the pipeline than Dealmaker determines it to be based on the qualifier values.).

Assessment—This category relates to criteria reviewed in order to determine whether (1) there is a valid opportunity, (2) the sales person can beat the competition, (3) the sales person can win the opportunity, and (4) the opportunity is worth winning (Example: Why are we pursuing the opportunity when there is insufficient revenue in the short or long term?)

It is also possible that some rules fall into combinations of categories. For example, a combination category might be the Collaboration map and the Political map. A rule that falls into the category might be what to do if a major contact on the Political map is not listed on the Collaboration map. Another example might be the Political Map and Opportunity; for example, what to do if the opportunity is at 70% closure probability but no direct contact has yet been made with the decision makers. Another example might be Decision Criteria, Competitors and Strategy; for example, what to do if the company is undertaking a frontal sales strategy when one of our competitors is in a better position to answer a number of the key decision criteria for our customer.

Rules are entered into the system using, in one embodiment, automatic SQL generation. When the administrator saves a rule using a rules editor user interface, the application transforms the [entity/attribute/operator value] set to a SQL query snippet (with necessary parameters), that will be executed for the specific opportunity, and saves it to the database. The entities are mapped to the required tables within the application database and the attributes are mapped to the specific fields in the tables (with any necessary foreign key references noted as part of the definition). The operator types are defined as SQL snippets.

So, for example each person who is listed as a “decision maker” should be identified with a “cause” that has an “impact” that leads to a “problem”. This is shown in the collaboration map depicted in FIG. 5. So in FIG. 5, the person who is responsible for forecasts is Jose Jimenez (shown on the map as “JJ”) and the “cause” associated with Jose Jimenez is “inaccurate forecasts”. If Jose Jimenez is a defined as a “decision maker”, the designation will appear in the operation map (FIG. 4). So one in general one would expect that each “decision maker” will be associated with a “cause” and if this is not the case then there is a problem with the either the designation of the person as a “decision maker” or the labeling of the “causes”

A rule might then be: If a person has an attribute that is a “decision maker” then he or she should show up as associated with a “cause” on the collaboration map and if this is not the case then the designation of “decision maker” and “cause” should be examined.

An example of this rule is:
Snippet 1
1. Entity: Contact (The contact person)
2. Attribute: Buyer Role (The role of that person in the organization)
3. Operator: Equals
4. Value: Decision Maker (The classification of that person)
   Snippet 2
5. Entity: Contact
6. Attribute: Collaboration Node Type (Whether the person appears on the collaboration map)
7. Operator: Does not equal
8. Value: Cause (What the person should be affiliated on the collaboration map.)

So in this case if the contact is designated a “decision maker” but he or she is not associated with a “cause” then this rule (which is made up of two snippets) will be satisfied and a comment will be generated, such as “The contact is designated as a decision maker but is not associated with any “cause”. Check to determine if the designation is wrong or a cause is mislabeled or missing.”

Each sub-section of the overall rule results in a snippet of SQL code. The application amalgamates these snippets into a single SQL query to retrieve the item type requested as part of the rule. A rule is considered “TRUE” if the SQL results in data being returned. In the above example, the rules may generate something similar to the following SQL code:

SELECT c.* FROM tblContact c, tblOpportunityContact oc,
tblBuyerRole br,
tblOppCollaborationMap ocm, tblOppCollaborationMapNodes ocmn,
tblCollaborationMapNodeType cmnt, tblOpportunity o

WHERE o.OpportunityID = ‘12345679’
AND o.OpportunityID = oc.OpportunityID
AND oc.ContactID = c.ContactID
And oc.BuyerRoleID = br.BuyerRoleID
And br.BuyerRoleDescription = ‘Decision Maker’
AND ocm.OpportunityID = o.OpportunityID
AND ocm.OppMapID = ocmn.OppMapID
AND ocmn.OppMapNodeTypeID = cmnt.OppMapNodeTypeID
AND cmnt.NodeTypeDesc = ‘Cause’
AND ocmn.ContactID = c.ContactID

The rule would result in the “advice” text being displayed if at least one Contact record is returned as a result of this query. Thus rules may be added to the system automatically.

By using this general framework a specific sales domain may be programmed into the system such that newer salespersons are guided during the sales process as if an experienced salesperson were guiding them. However, this is but one example of a domain where the present procedure can be used.

The term “sales domain” as used herein is used to generally mean a domain having an interaction between an individual who has an issue that he or she cares about and to whom something is being sold. That something may be a product, a service or a proposed behavior.

Thus the transformation of data input, applied against a set of knowledge and rules, incorporating variables from the data entered or from the relevant record from the database, and then presented as textual advice, can be applied more generally. For example in the field of strategic negotiation, which is itself a sales domain in which a proposed behavior of one of or both of the parties is being negotiated or sold to the other party, knowledge concepts apply pertaining to concessions, trades, positions and interests. Consideration of the consequences for each party of not reaching agreement is one of the core principles applied to strategic negotiation principles. Negotiators tend to focus on the impact to themselves of not reaching agreement, and rarely spend enough time considering the impact on the other party of not reaching agreement. Negotiators could therefore benefit from advice that highlights a potential imbalance between one party's ‘consequences of no agreement’ and that of their adversary as it relates to the attendant concessions, trades, positions and interests.

It is to be understood that the figures and descriptions of the invention have been simplified to illustrate elements that are relevant for a clear understanding of the invention, while eliminating, for purposes of clarity, other elements. Those of ordinary skill in the art will recognize, however, that these and other elements may be desirable. However, because such elements are well known in the art, and because they do not facilitate a better understanding of the invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention.

The examples presented herein are intended to illustrate potential and specific implementations of the invention. It can be appreciated that the examples are intended primarily for purposes of illustration of the invention for those skilled in the art. There may be variations to these diagrams or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the claims.

What is claimed is:

1. A computer-implemented method of coaching a salesperson to complete a sale, the method comprising the steps of:
entering into a database information about an entity to whom the salesperson wishes to sell;
entering into the database information about a sales opportunity of the entity;
instantiating objects in the database in response to the entered information;
executing a rule set over the instantiated objects; and
displaying the results of each rule in the rule set executing,
wherein the displaying includes a set of suggestions relating to completing the sale.

2. The method of claim 1 wherein the suggestions comprise one or more of: determining to whom the salesperson should make contact, determining any missing steps in an action plan, and determining competitive advantages.

3. The method of claim 1 wherein all the rules operate on all the objects in the database.

4. The method of claim 1 further comprising the step of constructing a collaboration map.

5. The method of claim 1 further comprising the step of constructing an entry organization structure.

6. The method of claim 1 further comprising generating a rule without regard for other rules.

7. The method of claim 1 wherein each of the rules belongs to one group of rules comprising: a political map; a strategy; a collaboration map; a prime action; decision criteria; a competitor; an opportunity, and an assessment.

8. A computer system for coaching a salesperson to complete a sale, the system comprising:
a processor; and
a database in communication with the processor, the database comprising a set of objects and a set of rules operating on the set of objects,
wherein the processor executes the set of rules on the objects to generate a set of suggestions relating completing a sale to the salesperson in response to the objects and rules.

9. The system of claim 8 further comprising:
an input device for entering into the database information about an entity to whom the salesperson wishes to sell; and
a display for displaying the set of suggestions relating to completing the sale.

10. The system of claim 6 wherein the rules operate on all the objects of the database.

11. A computer-implemented method of coaching a user in how to act within a domain, the method comprising the steps of:
entering into a database information about the domain;
instantiating objects in the database in response to the entered information;
executing a rule set over the instantiated objects; and
displaying the results of all executing rules of the rule set,
wherein the displaying includes a set of suggestions relating to desired actions within a domain.

12. The method of claim 11 wherein all the rules operate on all the objects in the database.

13. The method of claim 11 wherein the rules do not collide with other rules.

14. An article of manufacture comprising a memory module comprising a computer readable program that when executed:
enters into a database information about the domain;
instantiates objects in the database in response to the entered information;
execute a rule set over the instantiated objects; and
displays the results of all executing rules of the rule set,
wherein the displaying includes a set of suggestions relating to desired actions within a domain.
